(19) United States
(12) Patent Application Publication
(10) Pub. No.: US 2026/0328373 A1
(43) Pub. Date: Oct. 22, 2026

(54) Spray Gun Light

(71) Applicant: AEC Lighting Solutions Co., Ltd, Shanghai (CN)

(72) Inventors: Ai’xia Bian, Shanghai (CN); Xu’long Lei, Shanghai (CN)

(21) Appl. No.: 19/103,539

(22) PCT Filed: Nov. 21, 2023
(86) PCT No.: PCT/CN2023/132856

§ 371 Date: Feb. 12, 2025

(30) Foreign Application Priority Data
Aug. 21, 2023 (CN) 202322245216.1

(51) Int. Cl. F21V 21/088; F21L 4/08; F21V 15/01; F21V 21/14; F21V 21/40; F21V 23/04; F21V 33/00

(52) U.S. Cl. CPC F21V 21/0885; F21L 4/08; F21V 15/01; F21V 21/145; F21V 21/406; F21V 23/04; F21V 33/006

(57) ABSTRACT

The embodiments of the present invention disclose a spray gun light, comprising: a lamp body and a handle; the lamp body is rotatably connected to the handle. The lamp body includes a C-shaped lighting component and a baffle, with an opening on one side of the C-shaped lighting component. The baffle is movably connected to one side of the opening, capable of rotating toward the inner arc of the C-shaped lighting component, and automatically springing back when no external force is applied. The inner arc of the C-shaped lighting component is designed to fit securely against and clamp onto a spray gun when mounted. By providing an opening and a baffle on one side of the C-shaped lighting component, the spray gun light can be inserted from the side onto a robotic coating spray gun or a spindle coating line spray gun during operation, thereby enhancing illumination. When not in use, the spray gun light can be hung on a rod or rope via the opening to provide lighting. The rotatable handle allows the lamp body to be handheld, preventing interference with operator actions when mounted on the gun body. This invention improves ease of assembly and disassembly, ensures secure attachment to the gun body, and enhances illumination effectiveness during operation.

### TECHNICAL FIELD

The present invention relates to the field of lighting, and more particularly to a spray gun light.

### BACKGROUND ART

A spray gun typically comprises a gun body and a gun head, which are connected via a connecting mechanism. The gun head includes a nozzle, and the interior of the nozzle is welded with several metal round bars.

In certain scenarios, the spray position may be located deep within a structure, making it difficult to see clearly. Under such conditions, direct spraying may result in potential misalignment of the spray position, thereby adversely affecting operational accuracy.

To address this issue, the prior art often employs a ring-shaped lighting component mounted around the gun head near the nozzle to provide illumination. However, this ring-shaped lighting component is typically installed by sliding it onto the gun head from one end, which poses limitations in certain specific scenarios. For instance, enhanced illumination may be needed during the operation of the spray gun light, yet the existing designs often fail to provide sufficient flexibility. Additionally, when not in use, the spray gun light is difficult to store or retrieve, leading to inconvenience for the operator.

Existing solutions have limitations, and further improvements are required to address these issues effectively.

### SUMMARY OF THE INVENTION

To address the aforementioned problems, the present invention provides a spray gun light equipped with a lamp body featuring a notch. Whether the spray gun is a fixed spray gun on a production line or a handheld spray gun, and regardless of whether the spray gun is in operation, the spray gun light can be installed or removed from the side of the spray gun. Additionally, when the spray gun light needs to be hung for illumination or stored, the baffle can be opened to hang the lamp body on a rod or rope, thereby solving the issues of inconvenience in handling, placement, and assembly/disassembly associated with prior art.

To achieve the above objectives, the present invention provides a spray gun light comprising:
a lamp body and a handle;
the lamp body is rotatably connected to the handle;
the lamp body includes a C-shaped lighting component and a baffle, the C-shaped lighting component having an opening on one side, the baffle is movably connected to one side of the opening and is configured to rotate toward the inner arc of the C-shaped lighting component, wherein the inner arc of the C-shaped lighting component is designed to fit securely against and clamp onto a spray gun when mounted.

Optionally, the baffle, after rotating toward the inner arc, can automatically spring back when no external force is applied.

Optionally, a dirt-proof cover is mounted on the light-emitting side of the C-shaped lighting component, and the dirt-proof cover is connected to the C-shaped lighting component via a snap-fit connection.

Optionally, a spray gun fixing component is located on the inner wall of the C-shaped lighting component, and the spray gun fixing component is made of a highly elastic polymer material with reversible deformation properties.

Optionally, the spray gun fixing component protrudes from the inner wall of the C-shaped lighting component, and the end face of the spray gun fixing component inside the C-shaped lighting component is connected to a spring.

Optionally, a control knob is provided on the outer wall of the C-shaped lighting component, and the control knob is connected to the spray gun fixing component inside the C-shaped lighting component. The control knob is configured to lock the spray gun fixing component and adjust the height at which the spray gun fixing component protrudes from the inner wall of the C-shaped lighting component.

Optionally, the lamp body includes a fixing portion; the fixing portion is connected to the outer wall of the C-shaped lighting component and is positioned on the side opposite to the side where the baffle is located; the end of the handle is provided with a groove, and the fixing portion is disposed within the groove and movably connected to the handle via a pin.

Optionally, the lamp body is configured to rotate relative to the handle around a rotation axis, so that the light-emitting side of the lamp body faces the material spraying direction of the spray gun when mounted, while the handle remains perpendicular to the lamp body.

Optionally, the baffle is connected to one side of the opening of the C-shaped lighting component via a pin.

Optionally, the side of the handle is provided with anti-slip patterns.

Optionally, the handle includes a charging port; one side of the handle is equipped with a power switch and function adjustment buttons.

The above technical solutions provide the following beneficial effects:
By designing a notch and a baffle on one side of the C-shaped lighting component, the spray gun light can be quickly installed or removed even when the spray gun is in operation. Additionally, the baffle can automatically spring back, allowing the spray gun light to be operated with one hand for convenient installation. The spray gun light can also be hung on a rod or rope via the notch or used for hanging illumination. The rotatable handle ensures that the lamp body can be handheld, preventing interference with operator actions when mounted on the spray gun. This design improves the stability of the spray gun light when attached to the spray gun and further enhances illumination during operation.

### DESCRIPTION OF THE DRAWINGS

To provide a clearer illustration of the technical solutions in the embodiments of the present invention or in the prior art, the drawings used in the description of the embodiments or the prior art will be briefly introduced below. It is evident that the following drawings represent only some embodiments of the present invention. For those skilled in the art, other drawings can also be derived based on these drawings without any inventive effort.

FIG. 1 is a schematic structural diagram of the spray gun light provided in an embodiment of the present invention.

FIG. 2 is a schematic structural diagram showing the spray gun light in use, illustrating the rotatable connection between the lamp body and the handle.

FIG. 3 is a schematic structural diagram of the dirt-proof cover provided in the present invention, which is mounted on the light-emitting side of the C-shaped lighting component via a snap-fit connection.

### REFERENCE NUMBERS IN THE DRAWINGS

1—Lamp body;
101—C-shaped lighting component;
102—Baffle;
103—Fixing portion;
2—Handle;
3—Spray gun fixing component;
4—Control knob;
5—Power button;
6—Function adjustment button;
7—Dirt-proof cover;
100—Spray gun light;
200—Spray gun.

### DETAILED DESCRIPTION OF EMBODIMENTS

The following will describe the technical solutions of the present invention in detail with reference to the accompanying drawings of the embodiments. It is obvious that the described embodiments are only part of the possible embodiments of the present invention, and not all the embodiments. Any other embodiments derived by those skilled in the art, without the need for inventive labor, based on the embodiments of the present invention, are within the scope of protection of the present invention.

The existing annular spray gun lights require placing the side on a flat surface. When workers are performing operations, they often need to quickly change tools. Repeatedly taking the spray gun light can easily damage the surface of the lamp body. Furthermore, when not in use, a stable flat surface must be found to place the lamp, making both placing and retrieving inconvenient.

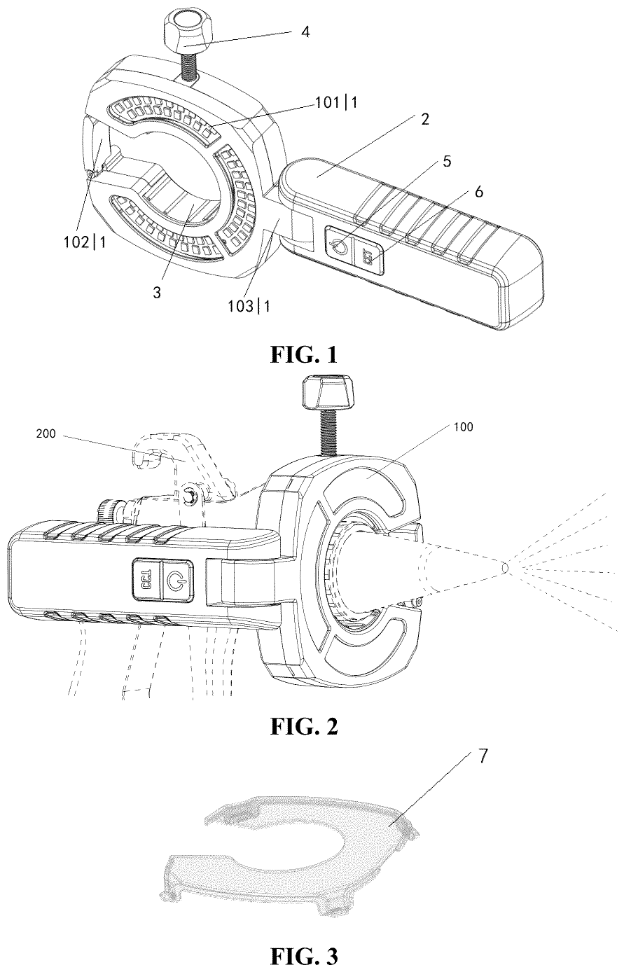

Therefore, to solve the above problems in the prior art, the embodiment of the present invention provides a spray gun light. FIG. 1 is a structural diagram of the spray gun light provided in the embodiment of the present invention. As shown in FIG. 1, the spray gun light includes: a lamp body 1 and a handle 2. The lamp body 1 is rotatably connected to the handle 2. The lamp body 1 includes a C-shaped lighting component 101 and a flap 102. One side of the C-shaped lighting component 101 has an opening, and the flap 102 is movably connected to the opening side. The flap 102 can rotate toward the inner arc direction of the C-shaped lighting component, and automatically returns when no external force is applied. The inner arc of the C-shaped lighting component 101 is used to fit and clamp the spray gun when mounted.

As shown in FIG. 1, the spray gun light consists of two main parts: the lamp body 1 and the handle 2. The lamp body 1 is rotatably connected to the handle 2, meaning the lamp body 1 can rotate relative to the handle 2. The lamp body 1 provides lighting and can be mounted on the spray gun for use. The operator can directly hold the spray gun and aim at the position to be sprayed, completing the spraying operation under adequate lighting.

FIG. 2 is a structural diagram showing the usage state of the spray gun light in the embodiment of the present invention. As shown in FIG. 2, since the lamp body 1 is rotatably connected to the handle 2, when the lamp body 1 is mounted on the spray gun 200 at the nozzle, the handle 2 can rotate relative to the lamp body 1.

The handle 2 can internally contain a power supply component or a battery to provide power to the lamp body 1.

As an optional embodiment, the inner wall of the C-shaped lighting component 101 is provided with a spray gun fixing component 3.

In an optional embodiment, the lamp body 1 includes the C-shaped lighting component 101 and the flap 102. The C-shaped lighting component 101 is a C-shaped structure with a notch, and its inner arc is used to mount the spray gun. When the spray gun is inserted into the inner arc of the C-shaped lighting component 101 near the nozzle, the inner wall of the C-shaped lighting component 101 tightly fits the outer wall of the spray gun, thereby securely mounting the spray gun light on the spray gun. The flap 102 is movably connected to one side of the notch of the C-shaped lighting component 101 and rotates via a rotating shaft. In this embodiment, the flap 102 is preferably designed to rotate toward the inner arc direction of the C-shaped lighting component 101 and can automatically rebound. When mounting on the spray gun, align the notch with the side of the spray gun and apply lateral force to push open the flap 102. After the spray gun light is mounted, the flap 102 automatically rebounds. Similarly, when the spray gun light needs to be hung on a horizontal bar, align the notch with the horizontal bar and push it, causing the flap 102 to open and mount on the bar. At this time, the flap 102 automatically rebounds.

In this embodiment, the opening of the C-shaped lighting component 101 is either equal to or smaller than the inner arc diameter of the C-shaped lighting component 101.

When the opening is equal to the inner arc diameter, it can be directly pushed into place by aligning it with the nozzle.

In this embodiment, further clarification is made regarding the alternative embodiment in which the opening of the C-shaped lighting component is smaller than the inner arc diameter:

As mentioned earlier, spray guns used for spraying or painting can be divided into handheld movable types and fixed types, such as robotic painting spray guns (Spray gun for robot painting) and spindle painting line spray guns (Spray gun for spindle painting line). The existing annular spray gun light is mounted on handheld movable spray guns. Since they can be turned on or off at any time and the spraying process does not require continuous operation, the annular spray gun light can be mounted when spraying is stopped. However, even when used on handheld movable spray guns, issues arise: sometimes the spray gun nozzle may have paint or other contaminants. When the annular spray gun light is mounted, it can either directly get contaminated with paint or dirt, or the contaminants may fall off during mounting and stick to the spray gun light, making it dirty.

In robotic painting spray guns and spindle painting line spray guns, due to poor indoor lighting, sometimes enhanced illumination is needed during operation. In this case, the existing annular spray gun light cannot be mounted.

To address these two issues, the mounting process of the spray gun light in this embodiment is as follows:
The size of the spray gun nozzle is becoming smaller.

Since the opening is smaller than the inner arc diameter, the spray gun light cannot be pushed laterally into place at the target position. Therefore, the opening needs to be aligned closer to the spray gun nozzle. A slight lateral push will open the flap 102 and allow the spray gun to be mounted into the C-shaped lighting component 101. At this point, the operator can pull the handle in the direction opposite to the spraying direction of the spray gun, moving the spray gun light into place, and ensure that the spray gun fixing component 3 mounted on the inner wall of the C-shaped lighting component 101 is tightly secured to the spray gun.

The spray gun fixing component 3 is made of a reversible deformable high-elasticity polymer material, preferably rubber. This increases the friction between the spray gun and the spray gun light, improving the stability of the mounting. Additionally, the rubber material can reduce wear between the spray gun and the C-shaped lighting component 101. Further, the surface of the spray gun fixing component 3 can be provided with ridges to further enhance the friction.

Because the opening is smaller than the inner diameter of the C-shaped lighting component 101, the inner arc of the C-shaped lighting component 101 is a large arc, exceeding half a circle. This ensures that the spray gun light is better fixed to the spray gun compared to the embodiment where the opening equals the inner arc diameter.

In this embodiment, preferably, the baffle 102 is connected to the C-shaped lighting component 101 via a return spring. When the baffle 102 is pushed into the inner arc and the applied force is removed, the spring allows the baffle to automatically return from its rotated state to a closed state. This enables single-handed operation of the spray gun light.

In another optional embodiment, a component linked to the baffle 102 can be installed within the inner arc of the C-shaped lighting component 101. When the inner arc of the spray gun light tightly fits the spray gun, the baffle 102 rebounds. When the inner arc of the spray gun light separates from the spray gun, the baffle 102 automatically opens. Thus, during the removal of the spray gun light, loosening the spray gun light in the spraying direction of the spray gun will cause the baffle 102 to automatically open, allowing the spray gun light to be easily removed laterally.

Specifically, a pressure-sensitive sensor or a mechanical structure can be utilized. These designs can be realized by those skilled in the art and should fall within the scope of protection of this application.

This embodiment allows the spray gun light to be installed and removed with one hand, eliminating the need to manually open or close the baffle 102, thereby enhancing the convenience of installation and removal.

As an optional embodiment, the interior of the C-shaped lighting component 101 is equipped with a light source. One side of the C-shaped lighting component 101 serves as the light-emitting surface, with a light-transmitting plate installed at the position corresponding to the light source. A protective cover is also provided on the light-emitting side of the C-shaped lighting component, attached via a snap-fit connection.

To achieve sufficient illumination, this embodiment distributes the light sources uniformly within the C-shaped lighting component 101, ensuring the light-emitting surface covers a large area uniformly. High-power SMD LEDs are utilized, achieving a brightness of 400 lumens.

The light-emitting surface of the C-shaped lighting component 101 is fully covered with a light-transmitting plate. The light generated by the light source can pass through the large-area light-transmitting plate, achieving single-sided large-area illumination of the C-shaped lighting component 101.

Additionally, the spray gun light can also be used independently. The operator can hold the handle 2, activate the lamp body 1, and use the spray gun light as a handheld illumination device. In handheld scenarios, the lamp body can be rotated to adjust the lighting angle. For example, during inspections, the operator can first use the spray gun light to accurately locate the spraying position and then use the spray gun for spraying. Of course, the spray gun light can also be used in other environments, without limitation in this application.

Furthermore, when used independently, the spray gun light can be stably placed on a flat surface due to the rotatable connection between the lamp body 1 and the handle 2. Specifically, the handle 2 can be placed on a table while the lamp body 1 is rotated to a suitable angle, enabling stable static illumination. Additionally, a magnet can be embedded in the handle 2, allowing the spray gun light to be securely attached to ferrous objects, such as an engine hood during car repairs.

Moreover, a groove can be provided on the non-light-emitting side of the lamp body 1 or the handle 2 to house a hook. When not in use, the hook can be stored in the groove. During use, the hook can be rotated out of the groove to suspend the spray gun light.

FIG. 3 is a structural diagram of the protective cover provided in the embodiment of the present invention. As shown in FIG. 3, to ensure the cleanliness of the light-emitting surface of the C-shaped lighting component 101, a protective cover 7 is attached to the light-emitting side of the C-shaped lighting component 101 via a snap-fit connection. When the spray gun light is not in use, the protective cover 7 can be installed on the light-emitting side to prevent dust or dirt from contaminating the surface. When the spray gun light is in use, the protective cover 7 can be easily removed. The snap-fit connection ensures the protective cover 7 is convenient to install and remove.

In a specific embodiment of this application, if the diameter of the spray gun is smaller than the inner arc diameter of the C-shaped lighting component 101, the spray gun light cannot be securely clamped to the spray gun. The spray gun may wobble inside the inner arc, and the spray gun light may detach if the spray gun tilts. To address this, in an optional embodiment of this specific scenario, the spray gun fixing component 3 protrudes from the inner wall of the C-shaped lighting component 101. The number of spray gun fixing components 3 can be adjusted as needed to compensate for the diameter difference between the inner arc of the C-shaped lighting component 101 and the spray gun, thereby ensuring stable assembly of the spray gun and the spray gun light.

As an optional embodiment, the spray gun fixing component 3 protrudes from the inner wall of the C-shaped lighting component 101 and is connected to the end face of the C-shaped lighting component 101 with a spring.

A portion of the spray gun fixing component 3 protrudes from the inner wall of the C-shaped lighting component 101, while another portion is located inside the C-shaped lighting component 101. The part inside the C-shaped lighting component 101 can be connected to an elastic element, preferably a spring.

In this way, when the diameter of the spray gun mounting area is approximately equal to the inner arc diameter of the C-shaped lighting component, inserting the spray gun into the inner arc pushes most of the spray gun fixing component 3 into the interior of the C-shaped lighting component 101. The spring force then provides a pushing force, ensuring secure fixation of the spray gun. When the diameter of the spray gun mounting area is smaller than the inner arc diameter of the C-shaped lighting component, more of the spray gun fixing component 3 protrudes under spring force, compensating for the diameter difference and ensuring secure fixation.

As an optional embodiment, there are two spray gun fixing components 3 positioned oppositely on the inner wall of the C-shaped lighting component 101, jointly securing the spray gun.

As an optional embodiment, the outer wall of the C-shaped lighting component 101 is equipped with a control knob 4. The control knob 4 is connected to the spray gun fixing component 3 inside the C-shaped lighting component 101. The control knob 4 can lock the height of the spray gun fixing component 3 protruding from the inner wall of the C-shaped lighting component 101.

The spray gun fixing component 3 can also be controlled via the control knob 4. The control knob 4 is positioned on the outer wall of the C-shaped lighting component 101, with one end extending into the C-shaped lighting component 101 and connected to the spray gun fixing component 3. For example, the control knob 4 can be linked to a bolt, and rotating the control knob 4 causes the bolt to push the spray gun fixing component 3 outward.

When the diameter of the spray gun mounting area is approximately equal to the inner arc diameter of the C-shaped lighting component, the control knob 4 is first loosened, the spray gun is inserted into the inner arc, and the control knob 4 is fine-tuned until the spray gun fixing component 3 provides sufficient pressure on the spray gun, ensuring stable fixation. When the diameter of the spray gun mounting area is smaller than the inner arc diameter of the C-shaped lighting component, the control knob 4 is first loosened, the spray gun is inserted into the inner arc, and the control knob 4 is rotated until the spray gun fixing component 3 exerts sufficient pressure on the spray gun. At this point, the spray gun fixing component 3 is locked at the desired height, ensuring stable fixation.

This adjustable mechanism allows the spray gun light to adapt to spray guns with varying diameters, ensuring a secure fit under different working conditions. For example, in environments with high vibrations, such as automated painting lines, the control knob 4 can securely lock the spray gun fixing component 3 in place, preventing any loosening during operation.

As an optional embodiment, there are two spray gun fixing components 3 positioned oppositely on the inner wall of the C-shaped lighting component 101, jointly securing the spray gun.

As an optional embodiment, the lamp body 1 includes a fixing part 103. The fixing part 103 is connected to the outer wall of the C-shaped lighting component 101, with the side of the fixing part 103 opposite to the side where the baffle 102 is located. The end of the handle 2 is provided with a groove. The fixing part 103 is positioned within the groove and is movably connected to the handle 2 via a pin.

As shown in FIG. 1, the lamp body 1 further includes a fixing part 103. The fixing part 103 is installed on the outer wall of the C-shaped lighting component 101, with its side opposite to the side of the baffle 102. The end of the handle 2 is equipped with a groove whose width is slightly larger than the width of the fixing part 103. When the fixing part 103 is positioned within the groove, it is movably connected to the handle 2 via a pin, ensuring that the lamp body 1 and the handle 2 can rotate relative to each other.

As an optional embodiment, the fixing part 103 may be either fixedly connected to or integrally formed with the C-shaped lighting component 101.

As an optional embodiment, the lamp body can rotate relative to the handle along a rotational axis. When the lamp body is mounted on the spray gun, the light-emitting surface of the lamp body faces the material ejection direction of the spray gun, while the handle is perpendicular to the lamp body.

The lamp body 1 can rotate relative to the handle 2, with a rotation angle that may be 90°, 120°, 180°, or other angles, preferably 180°. When the lamp body 1 can rotate 180°, the initial state is when the light-emitting surface of the lamp body is parallel to the control surface of the handle. The lamp body 1 can rotate backward (non-light-emitting side facing direction) by 90° or forward (light-emitting side facing direction) by 90°, expanding the illumination range. Alternatively, the lamp body 1 can rotate backward by 180° from the initial state, making it convenient to fold and store the spray gun light.

When the spray gun light is mounted on the spray gun, as shown in FIG. 2, the handle 2 forms a 90° angle with the lamp body 1. In other words, the handle 2 is parallel to the direction of the spray gun body. At this time, the center of gravity of the spray gun light 100 is close to the spray gun 200, preventing the total length of the lamp body 1 and the handle 2 from being too large, which could cause an offset in the center of gravity and inconvenience the operator.

As an optional embodiment, the baffle 102 is movably connected to one side of the opening of the C-shaped lighting component 101 via a pin. The baffle 102 can rotate relative to the opening side of the C-shaped lighting component 101 from a closed state to a 90°inward rotation.

As an optional embodiment, the handle 2 is provided with anti-slip patterns on both sides. The anti-slip patterns increase friction during handling, ensuring stability when holding the handle.

As an optional embodiment, one side of the handle 2 is equipped with a charging port, while one surface of the handle 2 is provided with a power button 5 and a function adjustment button 6.

Additionally, one side of the handle 2 is equipped with a charging port, preferably a Type-C model, which can recharge the internal power supply component of the handle 2 through an external power source. As shown in FIG. 1, the control surface of the handle 2 is also provided with a power button 5 and a function adjustment button 6. The power button controls the on/off state of the light source within the lamp body 1. The function adjustment button 6 adjusts the lighting modes and effects of the light source. For example, when the power button turns on the lamp body 1, the default mode is a low brightness level. Pressing the function adjustment button 6 once increases the brightness to a higher level, and pressing it twice consecutively adjusts the light color or sets the lighting effect to a flashing mode.

### ADVANTAGES OF THE TECHNICAL SOLUTION

The technical solution has the following beneficial effects:

By providing an opening and a baffle on one side of the C-shaped lighting component, the spray gun light can be quickly mounted or removed from the spray gun during operation.

The baffle can automatically rebound, enabling single-handed operation and convenient installation.

The spray gun light can also be hung on a rod or rope through the opening when not in use, or it can be used as a hanging light for illumination.

The rotatable handle ensures that the lamp body can be used as a handheld light, preventing interference with the operator during use on the spray gun.

The addition of spray gun fixing components improves stability when mounted on the spray gun and further enhances illumination effectiveness during operation.

The above specific embodiments further illustrate the purpose, technical solutions, and beneficial effects of the invention. It should be understood that the above content is only specific embodiments of the invention and is not intended to limit the scope of protection of the invention. Any modifications, equivalent replacements, or improvements made within the spirit and principles of the invention should fall within the scope of protection of the invention.

1. A spray gun light, characterized by comprising:
a lamp body and a handle;
the lamp body is rotatably connected to the handle;
the lamp body includes a C-shaped lighting component and a baffle, the C-shaped lighting component having an opening on one side, the baffle is movably connected to one side of the opening and is configured to rotate toward the inner arc of the C-shaped lighting component, wherein the inner arc of the C-shaped lighting component is configured to fit securely against and clamp onto a spray gun when mounted.

2. The spray gun light according to claim 1, characterized in that the baffle, after rotating toward the inner arc, can automatically spring back when no external force is applied.

3. The spray gun light according to claim 1, characterized in that:
a dirt-proof cover is mounted on the light-emitting side of the C-shaped lighting component, and the dirt-proof cover is connected to the C-shaped lighting component via a snap-fit connection.

4. The spray gun light according to claim 1, characterized in that:
a spray gun fixing component is located on the inner wall of the C-shaped lighting component, and the spray gun fixing component is made of a highly elastic polymer material with reversible deformation properties.

5. The spray gun light according to claim 4, characterized in that:
the spray gun fixing component protrudes from the inner wall of the C-shaped lighting component, and the end face of the spray gun fixing component inside the C-shaped lighting component is connected to a spring.

6. The spray gun light according to claim 4, characterized in that:
a control knob is provided on the outer wall of the C-shaped lighting component. The control knob locks the spray gun fixing component and adjusts the height at which the spray gun fixing component protrudes from the inner wall of the C-shaped lighting component.

7. The spray gun light according to claim 1, characterized in that:
the lamp body includes a fixing portion;
the fixing portion is connected to the outer wall of the C-shaped lighting component, positioned on the side opposite to the side where the baffle is located;
the end of the handle is provided with a groove, and the fixing portion is disposed within the groove and movably connected to the handle via a pin.

8. The spray gun light according to claim 1, characterized in that:
the lamp body is configured to rotate relative to the handle around a rotation axis, so that the light-emitting side of the lamp body faces the material spraying direction of the spray gun when mounted, while the handle remains perpendicular to the lamp body.

9. The spray gun light according to claim 1, characterized in that:
the baffle is connected to one side of the opening of the C-shaped lighting component via a pin.

10. The spray gun light according to claim 1, characterized in that:
the side of the handle is provided with anti-slip patterns.

11. The spray gun light according to claim 1, characterized in that:
the handle includes a charging port;
one side of the handle is equipped with a power switch and function adjustment buttons.
